(19) United States
(12) Patent Application Publication
(10) Pub. No.: US 2008/0159841 A1
(43) Pub. Date: Jul. 3, 2008

(54) Coordinated Boom Lift and Carriage Transfer

(76) Inventor: Philip L. Keller, New Philadelphia, OH (US)

Correspondence Address: NIXON & VANDERHYE, PC, 901 NORTH GLEBE ROAD, 11TH FLOOR, ARLINGTON, VA, 22203, US

(21) Appl. No.: 11/814,737

(22) PCT Filed: Feb. 10, 2006
(86) PCT No.: PCT/US06/04614

§ 371 Date: Jul. 25, 2007

Related U.S. Application Data
(60) Provisional application No. 60/651,634, filed on Feb. 11, 2005.

(51) Int. Cl. B66F 9/08; B66F 9/00

(52) U.S. Cl. 414/718

(57) ABSTRACT

A telescopic boom materials handling vehicle includes a vehicle chassis and a transfer carriage supported by the chassis and configured for longitudinal displacement relative to the chassis between the retracted position and an extended position. A telescopic boom is pivotably affixed at a first end to the transfer carriage. A control system controls operation of the telescopic boom to maintain a height of the load supported by the telescopic boom during longitudinal displacement by the transfer carriage, regardless of a terrain slope on which the vehicle chassis is supported.

### CROSS-REFERENCES TO RELATED APPLICATIONS

This application claims the benefit of U.S. Provisional Patent Application Ser. No. 60/651,634, filed Feb. 11, 2005, the entire content of which is herein incorporated by reference.

### BACKGROUND AND SUMMARY OF THE INVENTION

The Lull brand of telehandlers has a feature that provides horizontal load placement called transverse. This transverse feature incorporates an extendible telescopic boom carried by a longitudinally extendible transfer carriage. This feature gives the operator the ability to land loads in a horizontal motion without coordinating the boom lift and boom extend functions. The transverse action is accomplished by the horizontal movement of the entire boom via the transfer carriage. The transfer carriage travels on fore and aft longitudinal transfer rails welded to the telehandler chassis. The transfer carriage and boom extension travel on cam roller non-friction bearings.

Some of the advantages of the horizontal load placement feature are the ability to land loads at maximum lift height; horizontal placement of the load and ease of fork engagement and disengagement from the load; faster load cycle times; and additional horizontal reach capability at full boom extension.

A draw back to the horizontal load placement feature is the inability to compensate for the grade of the terrain without operator intervention. The transfer carriage follows the horizontal attitude of the chassis. If the machine is placed on a slope, the load will follow that slope when the transfer carriage is activated. To maintain a specified lift height on a grade while activating the transfer carriage requires an additional coordinated motion from the operator.

This invention compensates for the grade of the terrain and maintains the load in a true horizontal attitude throughout the entire length of the horizontal load placement action without any additional input from the operator. This is accomplished by adjusting the stroke of the boom lift cylinder(s) as the transfer carriage moves longitudinally on the chassis to either raise or lower the boom as required.

To accomplish this action, an angle sensor (gravity sensor) is used to monitor the attitude of the chassis with respect to the longitudinal horizontal plane as well as an angle sensor to monitor the boom angle to the chassis. Additionally, a length sensor is utilized to monitor the position of the transfer carriage on the chassis. This data is collected and monitored by an on board microprocessor.

In an exemplary embodiment of the invention, a telescopic boom materials handling vehicle includes a vehicle chassis, a transfer carriage supported on the chassis, and a telescopic boom pivotably affixed to the transfer carriage. The chassis includes a chassis angle sensor, preferably a gravity sensor, that detects an attitude of the chassis relative to true horizontal. The transfer carriage is configured for longitudinal displacement between a retracted position and an extended position. A length sensor monitors a position of the transfer carriage relative to the chassis. The telescopic boom includes a boom angle sensor that detects an angle of the boom relative to the chassis. A control system communicates with the chassis angle sensor, the length sensor and the boom angle sensor and controls operation of the telescopic boom via its lift cylinder(s) according to signals from the chassis angle sensor, the length sensor and the boom angle sensor. The telescopic boom preferably includes a load support apparatus at a second end thereof, which supports a load for displacement by the telescopic boom materials handling vehicle. In this context, the control system is configured to control operation of the telescopic boom based on the signals from the chassis angle sensor, the length sensor and the boom angle sensor to maintain the load support apparatus level during longitudinal displacement by the transfer carriage, regardless of a terrain slope on which the vehicle chassis is supported.

In another exemplary embodiment of the invention, a method is provided for maintaining a load supported on a telescopic boom materials handling vehicle level regardless of a terrain slope on which the vehicle is supported. The method includes the steps of detecting with the chassis angle sensor an attitude of the chassis relative to true horizontal; monitoring with the length sensor a position of the transfer carriage relative to the chassis; detecting with the boom angle sensor an angle of the boom relative to the chassis; and controlling operation of the telescopic boom according to the attitude of the chassis relative to true horizontal, the position of the transfer carriage relative to the chassis, and the angle of the boom relative to the chassis. The controlling step is practiced to maintain a height of the load at an initial lift height selected by an operator and, in particular, by operating the boom lift cylinder(s) to maintain the height of the load when the transfer carriage is displaced relative to the vehicle chassis. The telescopic boom may additionally include a load support apparatus at an end thereof opposite from the vehicle chassis for supporting the load, where the method further comprises maintaining an attitude of the load support apparatus regardless of the terrain slope on which the vehicle is supported and regardless of a position of the telescopic boom based on an operator selected position.

In yet another exemplary embodiment of the invention, a telescopic boom materials handling vehicle includes a vehicle chassis, a transfer carriage supported by the chassis and configured for longitudinal displacement relative to the chassis between a retracted position and an extended position, a telescopic boom pivotably affixed at a first end to the transfer carriage, and a control system controlling operation of the telescopic boom to maintain a height of a load supported by the telescopic boom during longitudinal displacement by the transfer carriage, regardless of a terrain slope on which the vehicle chassis is supported.

### BRIEF DESCRIPTION OF THE DRAWINGS

These and other aspects and advantages of the present invention will be described in detail with reference to the accompanying drawings, in which:

FIG. 1 is a side view of an exemplary coordinated boom lift and carriage transfer vehicle; and

FIG. 2 is a schematic block diagram of the sensor and control system of the present invention.

### DETAILED DESCRIPTION OF THE DRAWINGS

Materials handling vehicles are used for material handing jobs that require placing of a load in positions beyond the immediate area of the loader. For example, in construction jobs, it is desirable to lift heavy loads such as bricks and other materials and place them on floors within a building under construction, which requires movement of the load high above and forward from the loader. Such materials handling vehicles are known and details of the specific components thereof and their use and operation will not be provided herein. An exemplary vehicle is described in U.S. Pat. No. 4,147,263, which discloses a loader having extended transfer with a load carrying means supported at an end of a telescopic boom, which is pivotally secured to a transfer carriage. The transfer means can move the telescopic boom forward and rearward in addition to the reach attainable by extension, retraction, lifting and lowering of the boom. The contents of the '263 patent are herein incorporated by reference. Another exemplary vehicle is disclosed in U.S. Pat. No. 4,954,041, the contents of which are also herein incorporated by reference.

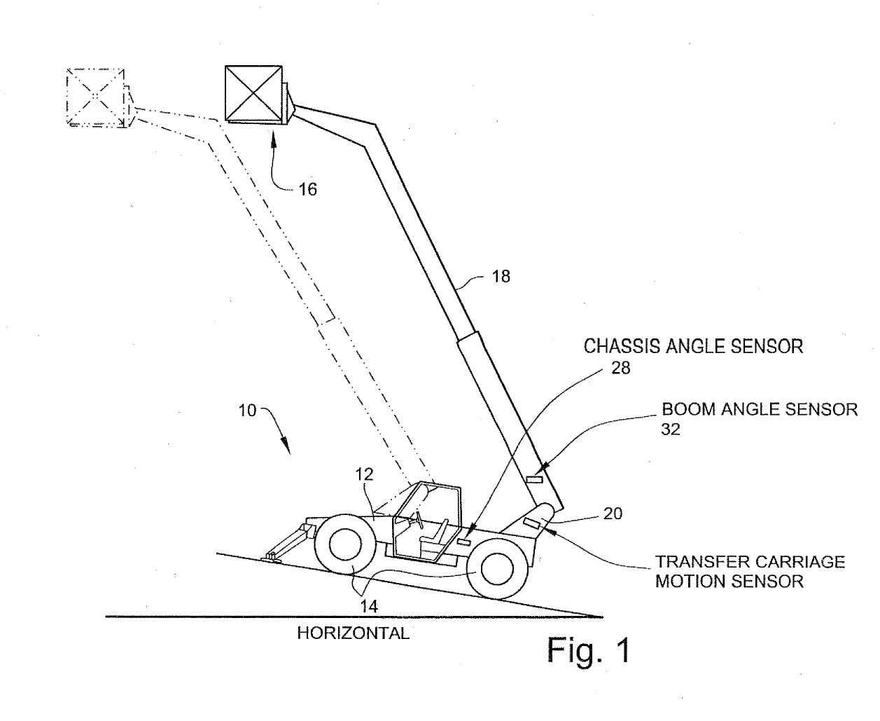

With reference to FIG. 1, the materials handling vehicle 10 generally includes a vehicle chassis 12 movably supported on wheels 14 that are driven through a suitable drive train by an engine mounted within the chassis 12. A load handling device such as a carriage and forks attachment 16 is pivotally supported at one end of a telescopic boom 18. The carriage and forks attachment 16 may be selectively tilted by virtue of a hydraulic cylinder or other drive means. The boom 18 is shown composed of two telescoping segments, although those of ordinary skill in the art will appreciate that the boom may be composed of three or more segments.

The telescopic boom 18 is pivotally secured at an opposite end of the carriage and forks attachment 16 to a transfer carriage 20 movably supported by the vehicle chassis 12. The transfer carriage 20 is configured for longitudinal displacement between a retracted position (as shown in solid line in FIG. 1) and an extended position (as shown in dash two-dot line in FIG. 1).

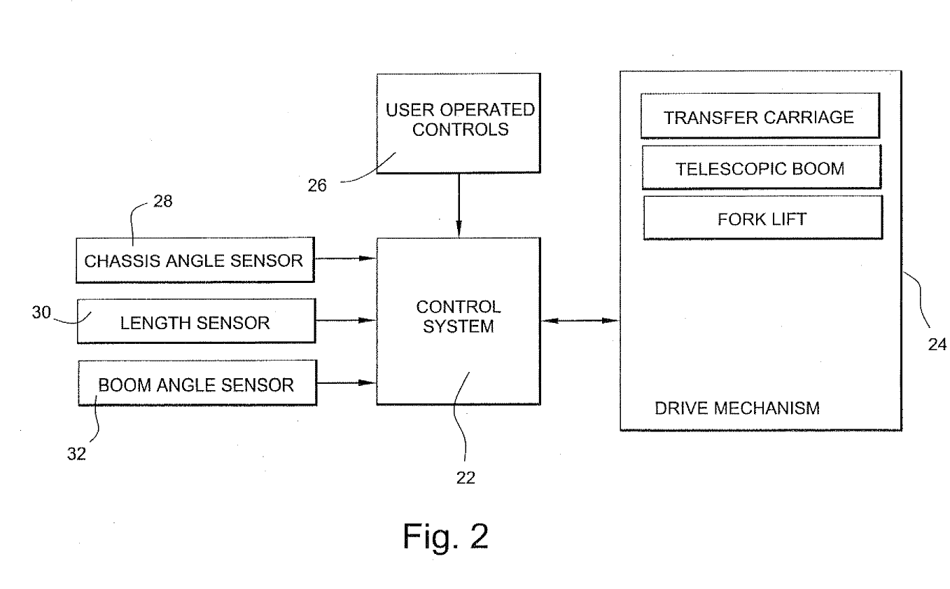

With continued reference to FIG. 1 and with reference to FIG. 2, a control system 22 communicates with the drive mechanism 24 of the transfer carriage 20 and the telescopic boom 18. The vehicle 10 includes user operated controls 26 as is conventional that provide input to the control system 22 to interact with and control the drive mechanism 24.

The chassis 12 is provided with a chassis angle sensor 28 that detects an attitude of the chassis 12 relative to true horizontal. In this context, the chassis angle sensor 28 is preferably a gravity sensor. A suitable exemplary angle sensor is available from Rieker, Inc. of Folcroft, Pa. The transfer carriage includes a length sensor 30 that monitors a position of the transfer carriage 20 relative to the chassis 12. The telescopic boom 18 is provided with a boom angle sensor 32 that monitors an angle of the boom 18 relative to the chassis 12 (or transfer carriage 20).

The control system 22 receives input from each of the chassis angle sensor 28, the length sensor 30, and the boom angle sensor 32 and controls operation of the telescopic boom 18 via its lift cylinder(s) according to signals from the sensors 28, 30, 32. In this context, after the operator has raised the boom 18 to a desired elevation and activated the transfer carriage 20, the boom lift cylinder(s) is supplied a flow of oil as required to either raise or lower the boom to maintain the height of the load with respect to the initial lift height selected by the operator. This action is accomplished by the control system 22 without additional input from the operator during transfer carriage motion. At any time during this activity, the height of the load can be changed by a deliberate input from the operator if and when desired. Additionally, the carriage and forks attachment 16 is pivoted without operator input to compensate for any change in boom angle to keep the load level or at the attitude set by the operator. If desired, the angle of the carriage and forks attachment 16 can be adjusted by the operator during the transfer carriage motion.

In this manner, the carriage and forks attachment 16 can be maintained level during longitudinal displacement by the transfer carriage 20 regardless of a terrain slope on which the vehicle chassis 12 is supported. With the input from the sensors 28, 30, 32, the control system 22 can calculate operating parameters in order to maintain an operator-selected height of the load during translation of the transfer carriage 20.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A telescopic boom materials handling vehicle comprising:
a vehicle chassis including a chassis angle sensor, the chassis angle sensor detecting an attitude of the chassis relative to true horizontal;
a transfer carriage supported by the chassis, the transfer carriage configured for longitudinal displacement between a retracted position and an extended position, wherein the transfer carriage includes a length sensor that monitors a position of the transfer carriage relative to the chassis;
a telescopic boom pivotably affixed at a first end to the transfer carriage and including a boom angle sensor, the boom angle sensor detecting an angle of the boom relative to the chassis; and
a control system communicating with the chassis angle sensor, the length sensor and the boom angle sensor and controlling operation of the telescopic boom according to signals from the chassis angle sensor including the attitude of the chassis relative to true horizontal, the length sensor including the position of the transfer carriage relative to the chassis, and the boom angle sensor including the angle of the boom relative to the chassis.

2. A telescopic boom materials handling vehicle according to claim 1, wherein the telescopic boom comprises a load support apparatus at a second end thereof, the load support apparatus supporting a load for displacement by the telescopic boom materials handling vehicle.

3. A telescopic boom materials handling vehicle according to claim 2, wherein the control system is configured to control operation of the telescopic boom based on the signals from the chassis angle sensor, the length sensor and the boom angle sensor to maintain the load support apparatus level during longitudinal displacement by the transfer carriage, regardless of a terrain slope on which the vehicle chassis is supported.

4. A telescopic boom materials handling vehicle according to claim 1, wherein the chassis angle sensor is a gravity sensor.

5. A method of maintaining a load supported on a telescopic boom materials handling vehicle level regardless of a terrain slope on which the vehicle is supported, the vehicle including a vehicle chassis including a chassis angle sensor, a transfer carriage including a length sensor, and a telescopic boom including a boom angle sensor, the method comprising:
detecting with the chassis angle sensor an attitude of the chassis relative to true horizontal;
monitoring with the length sensor a position of the transfer carriage relative to the chassis;
detecting with the boom angle sensor an angle of the boom relative to the chassis; and
controlling operation of the telescopic boom according to the attitude of the chassis relative to true horizontal, the position of the transfer carriage relative to the chassis, and the angle of the boom relative to the chassis.

6. A method according to claim 5, wherein the controlling step is practiced to maintain a height of the load at an initial lift height selected by an operator.

7. A method according to claim 6, wherein the controlling step is further practiced by operating the boom to maintain the height of the load when the transfer carriage is displaced relative to the vehicle chassis.

8. A method according to claim 5, wherein the telescopic boom comprises a load support apparatus at an end thereof opposite from the vehicle chassis, the load support apparatus supporting the load, and wherein the method further comprises maintaining an attitude of the load support apparatus regardless of the terrain slope on which the vehicle is supported and regardless of a position of the telescopic boom based on an operator-selected position.

9. A telescopic boom materials handling vehicle comprising:
a vehicle chassis;
a transfer carriage supported by the chassis, the transfer carriage configured for longitudinal displacement relative to the chassis between a retracted position and an extended position;
a telescopic boom pivotably affixed at a first end to the transfer carriage; and
a control system controlling operation of the telescopic boom to maintain a height of a load supported by the telescopic boom during longitudinal displacement by the transfer carriage, regardless of a terrain slope on which the vehicle chassis is supported.

10. A telescopic boom materials handling vehicle according to claim 9, further comprising a chassis angle sensor that detects an attitude of the chassis relative to true horizontal, a length sensor that monitors a position of the transfer carriage relative to the chassis, and a boom angle sensor that detects an angle of the boom relative to the chassis, wherein the a control system controls operation of the telescopic boom based on output from the chassis angle sensor, the length sensor and the boom angle sensor.
